(19) United States
(12) Patent Application Publication
(10) Pub. No.: US 2026/0212281 A1
(43) Pub. Date: Jul. 23, 2026

(54) METHOD, APPARATUS, DEVICE, AND MEDIUM FOR MANAGING MACHINE LEARNING MODEL

(71) Applicants: Beijing Zitiao Network Technology Co., Ltd., Beijing (CN); Lemon Inc., Grand Cayman (KY)

(72) Inventors: Chenghui Yu, Beijing (CN); Haoze Wu, Beijing (CN); Hongyu Xiong, Los Angeles, CA (US); Peiyi Li, Beijing (CN); Bingfeng Deng, Beijing (CN); Jie Xu, Singapore (SG)

(21) Appl. No.: 19/454,202

(22) Filed: Jan. 20, 2026

(30) Foreign Application Priority Data
Jan. 20, 2025 (WO) PCT/CN2025/073467

(51) Int. Cl. G06N 20/20

(52) U.S. Cl. CPC G06N 20/20

(57) ABSTRACT

A method, a device, and a medium for managing a machine learning model are provided. A prediction of a submission event between an object and a media item provided in the application is determined using a first machine learning model, the prediction of the submission event representing a probability that the object submits a response for a question associated with the media item. Based on the prediction of the submission event, a correction weight associated with the object is determined. A reference media item and a reference question associated with the reference media item are provided to the object in the application. In response to receiving a reference response submitted by the object for the reference question, the second machine learning model is updated based on the reference response and the correction weight, the second machine learning model describing an association relationship between the object and the reference media item.

### CROSS REFERENCE

This application claims priority to PCT Application No. PCT/CN2025/073467, filed on Jan. 20, 2025, and entitled “METHOD, APPARATUS, DEVICE, AND MEDIUM FOR MANAGING MACHINE LEARNING MODEL”, the entirety of which is incorporated herein by reference.

### FIELD

Implementations of the disclosure generally relate to the field of computers, and in particular, to a method, an apparatus, a device, and a computer-readable storage medium for managing a machine learning model.

### BACKGROUND

Machine learning techniques have been widely used to perform a variety of tasks. For example, in a recommendation scenario, various media items may be recommended to an object in an application by using a machine learning model (for example, a recommendation model). To improve the accuracy of the recommendation, questions may be provided to the object in order to ask if the recommended media item is liked. Some objects may agree to answer the questions and submit responses, but some objects may refuse to answer questions. At this time, the collected responses may only reflect the perspective of the objects that agree to submit the responses, but fail to reflect the perspective of the objects that refuse to submit the responses. At this time, if the recommendation model is updated based on the collected responses, the recommendation model may be caused to ignore the object that refuses to submit the response. In this case, it is expected to reduce the deviation in the training sample, and the machine learning model may be updated in a more accurate manner.

### SUMMARY

In a first aspect of the disclosure, a method for managing a machine learning model is provided. In the method, a prediction of a submission event between an object and a media item provided in an application is determined using a first machine learning model, the prediction of the submission event representing a probability that the object submits a response for a question associated with the media item. Based on the prediction of the submission event, a correction weight associated with the object is determined. A reference media item and a reference question associated with the reference media item are provided to the object in the application. In response to receiving a reference response submitted by the object for the reference question, a second machine learning model is updated based on the reference response and the correction weight, the second machine learning model describing an association relationship between the object and the reference media item.

In a second aspect of the disclosure, an apparatus for managing a machine learning model is provided. The apparatus includes: a prediction determining module configured to determine a prediction of a submission event between an object and a media item provided in an application using a first machine learning model, the prediction of the submission event representing a probability that the object submits a response for a question associated with the media item; a weight determining module configured to determine a correction weight associated with the object based on the prediction of the submission event; a providing module configured to provide to the object in the application a reference media item and a reference question associated with the reference media item; and an updating module configured to update a second machine learning model based on a reference response submitted by the object for the reference question and the correction weight in response to receiving the reference response, the second machine learning model describing an association relationship between the object and the reference media item.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a non-transitory computer-readable storage medium having stored thereon a computer program which, when executed by a processor, causes the processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the contents described in this disclosure are not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, wherein:

FIG. 1 shows a block diagram of an application environment according to an implementation of the disclosure;

FIG. 2 shows a block diagram of managing a machine learning model according to some implementations of the disclosure;

FIG. 3 shows a block diagram of a process of updating a machine learning model according to some implementations of the disclosure;

FIG. 4 shows a block diagram of a problem according to some implementations of the disclosure;

FIG. 5 shows a flowchart of a method for managing a machine learning model according to some implementations of the disclosure;

FIG. 6 shows a block diagram of an apparatus for managing a machine learning model according to some implementations of the disclosure; and

FIG. 7 shows a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The terms “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, in a manner of a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and user authorization obtaining process is merely illustrative, and does not constitute a limitation on implementations of the disclosure, and other manners of meeting related laws and regulations may also be applied to implementations of the disclosure.

The term “in response to” as used herein means a state in which a respective event occurs or a condition is satisfied. It will be appreciated that the timing of execution of a subsequent action performed in response to the event or the condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

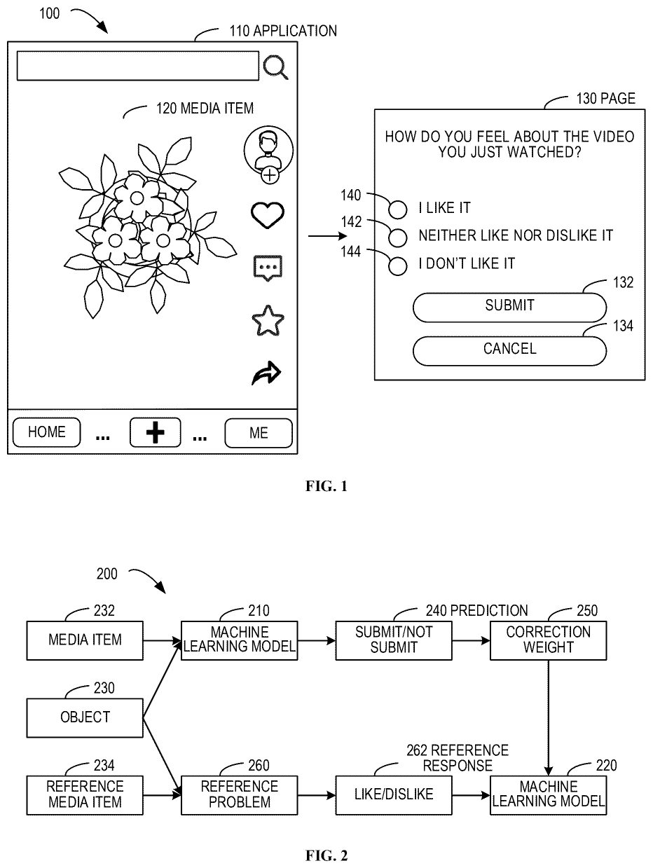

Machine learning techniques have been widely used to perform a variety of tasks. For example, in a recommendation scenario, various media items may be recommended to an object in an application by using a machine learning model (for example, a recommendation model). FIG. 1 is a block diagram 100 of an application environment according to some implementations of the disclosure. As shown in FIG. 1, a media item 120 may be provided to the object (e.g., a user of the application 110) in an application 110, and the media item 120 may include multiple types, for example, including but not limited to a video, a short video, a music, a text, an image, a game, or a rich media data including combination(s) of the above multiple types. For ease of description, the video is described as an example of the media item in the context of the disclosure.

To improve the accuracy of the recommendation, questions may be provided to the object through a questionnaire, for example, whether the recommended media item is liked may be queried, the recommended media item may be requested to be annotated and classified, and the like. Different objects may have different feedback on the media item 120, for example, some objects may like the media item 120, and the objects may view all media items and may perform actions such as giving a like, commenting, and forwarding. Alternatively and/or additionally, some objects may not like the media item 120, and may skip the media item 120 and browse the next media item, etc. To further optimize the performance of the recommendation model, a questionnaire page 130 may be provided in the application 110, for example, a question may be presented to various objects of the application 110 (e.g., how do you feel about the video you just browsed?), and a response to the question 130 from the object is received.

The page 130 includes a control 134 for refusing to submit a response, and in response to receiving an interaction request with the control 134, the page may be cancelled. The page 130 may further include a control 132 for submitting a response, and may include one or more predetermined responses. For example, a control 140 corresponds to a positive response “I like”, a control 142 corresponds to a neutral response “i.e., neither like nor dislike”, and a control 144 corresponds to a negative response “I don't like”. The object may select the desired response and press the control 132 to submit the selected response. The response from the object may be collected, and the response may be used to learn an association relationship between the object and the media item (e.g., a degree of liking of the object with respect to the media item), thereby improving the accuracy of the recommendation.

However, as shown in FIG. 1, some objects may agree to answer questions and submit responses, but some objects may refuse to answer the questions. At this time, the collected response may only reflect the perspective of the object that agrees to submit the response, but does not reflect the perspective of the object that refuses to submit the response. At this time, if the recommendation model is updated based on the collected response, the recommendation model may be caused to ignore the object that refuses to submit the response. In this case, it is expected to reduce the deviation in the training sample, and the machine learning model may be updated in a more accurate manner.

### Summary of Managing Machine Learning Model

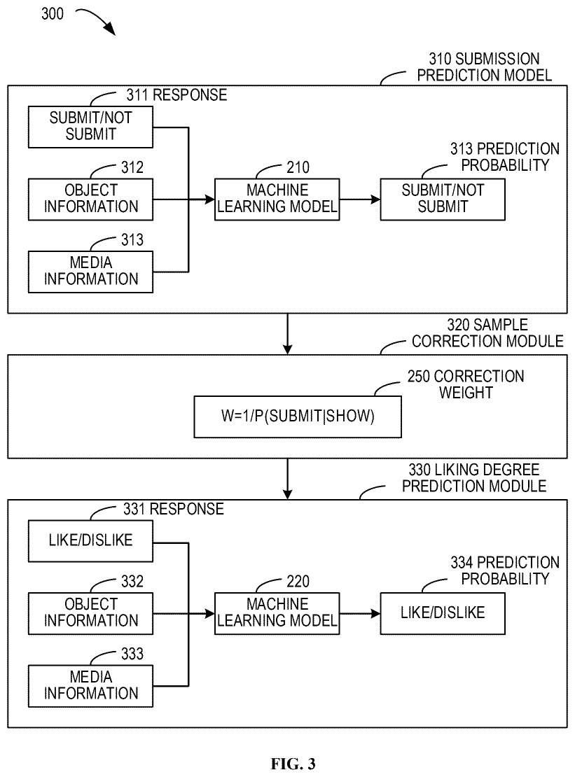

In order to at least partially solve the deficiencies in the prior art, according to an implementation of the disclosure, a method for managing a machine learning model is provided. According to the method, the deviation in the training data can be eliminated, and the accuracy of the machine learning model is further improved. Referring to FIG. 2, a summary is described according to one implementation of the disclosure, and FIG. 2 shows a block diagram 200 of managing a machine learning model according to some implementations of the disclosure. As shown in FIG. 2, a prediction 240 of a submission event between an object 230 and a media item 232 provided in the application may be determined using a first machine learning model (e.g., a machine learning model 210), the prediction of the submission event may represent a probability that the object 230 submits a response for a question associated with the media item 232.

The question shown in the page 130 may be provided to the object 230, i.e., asking whether the object likes the media item 120 just browsed. Here, the machine learning model 210 may be a model for predicting whether an object will answer the question, and the prediction 240 may represent a probability that the object answers the question (e.g., between 0 and 1). The machine learning model 210 may be trained using historical data samples, assuming that a question is provided to the object every day in the past 30 days, whereas only one response is received, and at this time, the prediction 240 may, for example, be represented as a probability of “1/30”. Alternatively and/or additionally, whether the object submits a response may further depend on relevant information of the media item. For example, assuming that the media item is of a music type, more responses may be collected; and assuming that the media item is of a sports type, fewer responses may be collected. At this point, the prediction 240 is further dependent on the specific information of the media item.

A correction weight 250 associated with the object 230 may be determined based on the prediction 240 of the submission event. In the application, a reference media item 234 and a reference question 260 associated with the reference media item 234 may be provided to the object 230. In response to receiving a reference response 262 submitted by the object 230 for the reference question 260, a second machine learning model (e.g., a machine learning model 220) may be updated based on the reference response 262 and the correction weight 250. The second machine learning model may describe an association relationship between the object 230 and the reference media item 234. It should be understood that the machine learning model 220 may represent a degree of liking of the object 230 with respect to the reference media item 234, which may represent a recommendation index recommending the reference media item 234 to the object 230. The higher the degree of liking, the higher the probability that the reference media item 234 is recommended to the object 230.

With the implementations of the disclosure, the data deviation in the training sample may be corrected based on the probability that the object submits the response, thereby improving the importance of the training sample of the object corresponding to a lower submission probability. In this way, the training data of different objects corresponding to different submission probabilities may be considered in a more comprehensive and accurate manner, thereby improving the accuracy of the trained machine learning model.

### Detailed Process of Managing Machine Learning Model

Having described a summary according to some implementations of the disclosure, more details regarding a method for managing a machine learning model will be described below. FIG. 3 shows a block diagram 300 of a process of updating a machine learning model according to some implementations of the disclosure. As shown in FIG. 3, a plurality of modules may be used to implement the technical solution described above. According to some implementations of the disclosure, a submission prediction module 310 may be configured to predict whether a certain object will submit a response to a received question. In other words, relevant information of the object may be input to the submission prediction module 310, and the submission prediction module 310 may output a submission probability of the object. Alternatively and/or additionally, relevant information of the media item may be further input to the submission prediction module 310, at which point the submission prediction module 310 may operate in a more refined manner and output the submission probability of the object for a problem associated with the media item.

According to some implementations of the disclosure, the machine learning model 210 may be trained using historical data. For example, a first reference sample (the reference sample is also referred to as a training sample) may be obtained. The first reference sample includes first object information of a first reference object, first media information of a first reference media item, and a first reference submission event between the first reference object and the first reference media item, and the first reference media item is provided to the first reference object. The first machine learning model is updated based on the first reference sample. With some implementations of the disclosure, knowledge about the submission probability may be obtained based on the historical data of whether the object submits a response by using a powerful learning capability of the machine learning model. In a running process of the application, the questionnaire of the objects about the related questions for the provided media items and the responses of the objects to the questionnaire may be collected.

In a process of obtaining the first reference sample, the first reference media item and a first reference question associated with the first reference media item may be provided to the first reference object; and based on a first reference response submitted by the first reference object for the first reference question, the first reference submission event in the first reference sample is determined. For the example in FIG. 1, assuming that an interaction request for the control 132 is received (i.e., a click for a submit control), a response 311 may be determined to indicate a “positive” submission event, and a positive sample is constructed. Assuming that an interaction request for the control 134 is received (i.e., a click for a cancel control), the response 311 may be determined to indicate a “negative” submission event and a negative sample is constructed.

It should be understood that object information 312 may include various aspects of contents, for example, may include, but is not limited to, an identifier of the object, device information related to the object (for example, a type and a model of an operating system, etc.), and the like. The media information may include various aspects of contents, for example, including but not limited to, an identifier of the media item, a length of time of the media item, content of the media item, and/or the like. The object information, the media information, and the submission event may be mapped to a feature space, and an association relationship among these three may be learned by using the machine learning model 210.

According to some implementations of the disclosure, the machine learning model 210 may be utilized to output a prediction probability 313, also referred to as a submission probability. The submission probability may be expressed as P(submit|show), where submit represents an event that an object submits a response, show represents an event that a problem to be provided to the object in the application, and P(submit|show) represents a probability of submitting a response for the question in a case that the object has received the question. A probabilistic model may be constructed using the machine learning model 210 in order to output a submission probability P(submit|show). According to some implementations of the disclosure, in a process of updating the first machine

learning model based on the first reference sample, a first prediction of the first reference submission event may be determined by the first machine learning model based on the first object information and the first media information; and the first machine learning model is updated based on a first difference between the first reference submission event and the first prediction. Specifically, an initial machine learning model 210 may be acquired, a loss function may be constructed based on the first difference, and the machine learning model 210 is trained in a direction that minimizes the loss function. According to some implementations of the disclosure, a large number of reference samples may be generated based on historical data of a large number of users. Further, the machine learning model 210 may be continuously updated in an iterative manner. In this way, the machine learning model 210 may continuously accumulate knowledge about the submission probability, thereby improving the accuracy of the machine learning model 210.

According to some implementations of the disclosure, after determining the prediction of the submission event (i.e., the submission probability), a corresponding correction weight may be determined based on the submission probability. In particular, the correction weight may decrease as the prediction of the submission event increases, e.g., inversely proportional to the prediction of the submission event. With continued reference to FIG. 3, the correction weight 250 may be determined by a sample correction module 320. Assuming that the submission probability is represented as P(submit|show), the correction weight may be expressed as W=1/P(submit|show). The recommendation prediction model may be corrected using the submission probability 313 (i.e., P(submit|show)) output by the machine learning model 210. Specifically, each training sample may be multiplied by the correction weight of W=1/P(submit|show), and then the sample with the correction weight may be used for training. It should be understood that the formula herein is merely illustrative, and alternatively and/or additionally, other formulas may be used to determine the correction weight, as long as the correction weight decreases as the submission probability increases. According to some implementations of the disclosure, the second machine learning model may

be updated based on the reference response and the correction weight. Specifically, a second reference sample may be determined based on the reference response, and the second reference sample includes second object information of the object, second media information of the reference media item, and the reference response; and the second machine learning model is updated based on the second reference sample and the correction weight. Here, the second reference sample refers to a training sample for updating the machine learning model 220. Specifically, in a liking degree prediction module 330, a prediction probability 334 for likes/dislikes may be determined.

According to some implementations of the disclosure, the first object information may be different from the second object information, and the first media information may be different from the second media information. Specifically, there may be an intersection between the first object information and the second object information, and there may be an intersection between the first media information and the second media information. With some implementations of the disclosure, a dimension of a relevant feature may be selected based on respective points of interest of the first machine learning model and the second machine learning model, respectively, thereby improving the accuracy of various machine learning models.

In the liking degree prediction module 330, a response 331 for the question, i.e., a response for the question associated with the media item (like/dislike), may be obtained. The training sample may be constructed based on the object information 332 and the media information 333 and the response 331 to train the machine learning model 220. Here, the object information 332 may include various aspects of contents, for example, may include but is not limited to, an identifier of the object, device information related to the object (for example, a type and a model of the operating system, etc.), a time point at which the object receives the question, and the like. The media information 333 may include various aspects of contents, for example, including but not limited to, an identifier of the media item, a length of time of the media item, a resolution of the media, a classification of the media, and/or the like. The object information 332, the media information 333, and the response 331 may be mapped to a feature space, and an association relationship among the three may be learned by using the machine learning model 220.

According to some implementations of the disclosure, in a process of updating the second machine learning model based on the second reference sample and the correction weight, a second prediction of the reference response may be determined based on the second object information and the second media information; and the second machine learning model is updated based on the correction weight and a second difference between the reference response and the second prediction. For example, the object information 332 and the media information 333 may be input to the machine learning model 220, and the second prediction from the machine learning model 222 may be received, the second difference between the second prediction and a truth value in the response 331 may be determined. Further, the machine learning model 220 is updated based on the second difference and the correction weight W=1/P(submit|show). With some implementations of the disclosure, since the submission probability is less than or equal to 1, the correction weight is greater than or equal to 1. In this way, the influence of the response of the object corresponding to a lower submission probability may be strengthened, thereby enabling the machine learning model 220 to more consider the perspective of the object corresponding to the lower submission probability. According to some implementations of the disclosure, in the process of updating the second

machine learning model based on the second difference and the correction weight, a loss for updating the second machine learning model may be determined based on a product of the second difference and the correction weight; and the second machine learning model is updated based on the loss. In the context of the disclosure, the second difference represents a degree of influence of the response of the object corresponding to the lower submission probability on a parameter of the machine learning model, the loss is determined based on the product of the second difference and the correction weight, and the influence of the response of the object corresponding to the lower submission probability may be strengthened, so that the machine learning model 220 may more consider the perspective of the object corresponding to the lower submission probability.

With some implementations of the disclosure, the data deviation in the training sample may be corrected based on the probability that the object submits the response, thereby improving the importance of the training sample of the object corresponding to the lower submission probability. In this way, the training data of different objects corresponding to different submission probabilities may be considered in a more comprehensive and accurate manner, thereby improving the accuracy of the trained machine learning model.

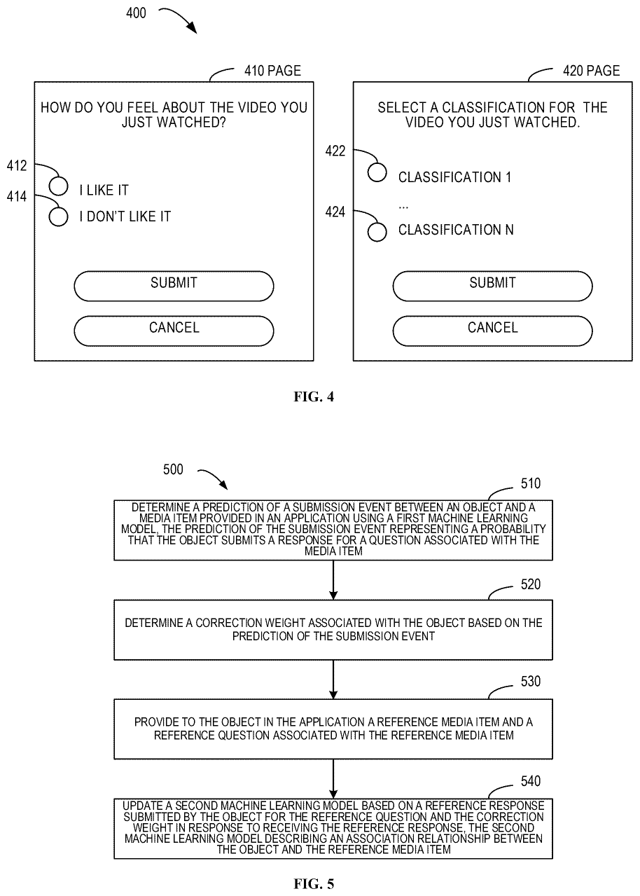

According to some implementations of the disclosure, the response may include at least any of: an evaluation specified by the object for the media item; or a classification specified by the object for the media item. More details are described with reference to FIG. 4, which shows a block diagram 400 of a problem according to some implementations of the disclosure. As shown in FIG. 4, a question shown on a page 410 is to ask whether the object likes the video just browsed. A control 412 corresponds to a positive evaluation of “I like,” and a control 414 corresponds to a negative evaluation of “I don't like”. A page 420 shows a question as asking for a classification of a media item. A control 422 corresponds to a classification 1 that it is expected to reduce a recommendation frequency (e.g., an inferior video), and a control 424 corresponds to a classification N that it is expected to reduce a recommendation frequency. With some implementations of the disclosure, the specific content of the question may be adjusted according to a query target, so as to collect more information that helps improve the accuracy of the recommendation from the response.

The method described above may be used in the application to recommend the media items to the object. Experimental data shows that when the question relates to the liking degree, the liking degree that is fed back in the questionnaire is improved after the above method is adopted. When the question relates to the media item classification that it is expected to reduce the recommendation frequency, a proportion of the inferior video that is fed back in the questionnaire is reduced after the above method is adopted.

According to some implementations of the disclosure, the media item recommended to the object may be selected using the second machine learning model described above. Specifically, a target media item may be selected from a plurality of media items by the second machine learning model based on the second object information; and the target media item is provided to the object. Assuming that it is expected to recommend a media item to the object, an object feature and a media feature may be input to the machine learning model 220, and whether the object likes the media item is determined. The media item with a higher liking degree may be preferentially recommended to the object.

Alternatively and/or additionally, the machine learning model 220 may be combined with an existing recommendation model. For example, an original recommendation index associated with the object and the media item may be determined by the recommendation model. Further, a final recommendation index may be determined based on the original recommendation index and a liking degree output by the recommendation prediction module, and then a certain media item is recommended to the object based on the final recommendation index. For example, the final recommendation index may be determined based on a weighted summation of the original recommendation index and the liking degree. With some implementations of the disclosure, in a process of recommending the media item, on one hand, the recommendation index determined based on the existing technical solution may be considered, and on the other hand, the liking degree after the correction determined based on the questionnaire may be considered, so that the media item may be recommended to the object in a more accurate manner.

With the implementations of the disclosure, the data deviation in the training sample may be corrected based on the probability that the object submits the response, thereby improving the importance of the training sample of the object corresponding to a lower submission probability. In this way, the training data of different objects corresponding to different submission probabilities may be considered in a more comprehensive and accurate manner, thereby improving the accuracy of the trained machine learning model.

### Example Process

FIG. 5 shows a flowchart of a method 500 for managing a machine learning model according to some implementations of the disclosure. At block 510, a prediction of a submission event between an object and a media item provided in the application is determined using a first machine learning model, and the prediction of the submission event represents a probability that the object submits a response for a question associated with the media item. At block 520, a correction weight associated with the object is determined based on the prediction of the submission event. At block 530, a reference media item and a reference question associated with the reference media item are provided to the object in the application. At block 540, in response to receiving a reference response submitted by the object for the reference question, a second machine learning model is updated based on the reference response and the correction weight, and the second machine learning model describes an association relationship between the object and the reference media item.

According to some implementations of the disclosure, the first machine learning model is determined based on: obtaining a first reference sample, the first reference sample including first object information of a first reference object, first media information of a first reference media item, and a first reference submission event between the first reference object and the first reference media item, and the first reference media item being provided to the first reference object; and updating the first machine learning model based on the first reference sample.

According to some implementations of the disclosure, obtaining the first reference sample includes: providing to the first reference object the first reference media item and a first reference question associated with the first reference media item; and determining the first reference submission event in the first reference sample based on a first reference response submitted by the first reference object for the first reference question.

According to some implementations of the disclosure, updating the first machine learning model based on the first reference sample includes: determining a first prediction of the first reference submission event by the first machine learning model based on the first object information and the first media information; and updating the first machine learning model based on a first difference between the first reference submission event and the first prediction.

According to some implementations of the disclosure, the correction weight decreases as the prediction of the submission event increases.

According to some implementations of the disclosure, updating the second machine learning model based on the reference response and the correction weight includes: determining a second reference sample based on the reference response, the second reference sample including second object information of the object, second media information of the reference media item, and the reference response; and updating the second machine learning model based on the second reference sample and the correction weight.

According to some implementations of the disclosure, updating the second machine learning model based on the second reference sample and the correction weight includes: determining a second prediction of the reference response by the second machine learning model based on the second object information and the second media information; and updating the second machine learning model based on the correction weight and a second difference between the reference response and the second prediction.

According to some implementations of the disclosure, updating the second machine learning model based on the second difference and the correction weight includes: determining a loss for updating the second machine learning model based on a product of the second difference and the correction weight; and updating the second machine learning model based on the loss.

According to some implementations of the disclosure, the first object information is different from the second object information, and the first media information is different from the second media information.

According to some implementations of the disclosure, the response includes at least any of: an evaluation specified by the object for the media item; or a classification specified by the object for the media item.

According to some implementations of the disclosure, the method further includes: selecting a target media item from a plurality of media items by the second machine learning model based on the second object information; and providing the target media item to the object.

### Example Apparatus and Device

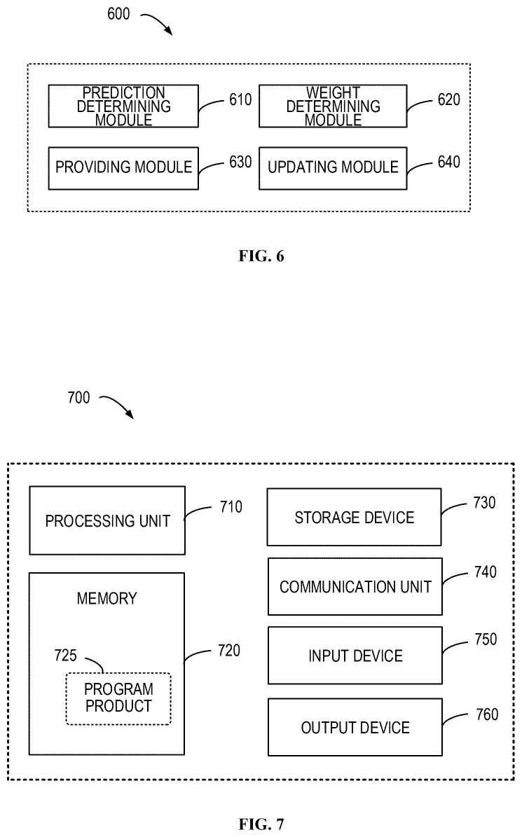

FIG. 6 shows a block diagram of an apparatus 600 for managing a machine learning model according to some implementations of the disclosure. The apparatus includes: a prediction determining module 610 configured to determine a prediction of a submission event between an object and a media item provided in an application using a first machine learning model, the prediction of the submission event representing a probability that the object submits a response for a question associated with the media item; a weight determining module 620 configured to determine a correction weight associated with the object based on the prediction of the submission event; a providing module 630 configured to provide to the object in the application a reference media item and a reference question associated with the reference media item; an updating module 640 configured to update a second machine learning model based on a reference response submitted by the object for the reference question and the correction weight in response to receiving the reference response, the second machine learning model describing an association relationship between the object and the reference media item.

According to some implementations of the disclosure, the first machine learning model is determined based on: obtaining a first reference sample, the first reference sample including first object information of a first reference object, first media information of a first reference media item, and a first reference submission event between the first reference object and the first reference media item, and the first reference media item being provided to the first reference object; and updating the first machine learning model based on the first reference sample.

According to some implementations of the disclosure, obtaining the first reference sample includes: providing to the first reference object the first reference media item and a first reference question associated with the first reference media item; and determining the first reference submission event in the first reference sample based on a first reference response submitted by the first reference object for the first reference question.

According to some implementations of the disclosure, the updating module is further configured to: determine a first prediction of the first reference submission event by the first machine learning model based on the first object information and the first media information; and update the first machine learning model based on a first difference between the first reference submission event and the first prediction.

According to some implementations of the disclosure, the correction weight decreases as the prediction of the submission event increases.

According to some implementations of the disclosure, the updating module is further configured to include: determining a second reference sample based on the reference response, the second reference sample including second object information of the object, second media information of the reference media item, and the reference response; and updating the second machine learning model based on the second reference sample and the correction weight.

According to some implementations of the disclosure, the updating module is further configured to: determine a second prediction of the reference response by the second machine learning model based on the second object information and the second media information; and update the second machine learning model based on the correction weight and a second difference between the reference response and the second prediction.

According to some implementations of the disclosure, the module is further configured to: determine a loss for updating the second machine learning model based on a product of the second difference and the correction weight; and update the second machine learning model based on the loss.

According to some implementations of the disclosure, the first object information is different from the second object information, and the first media information is different from the second media information.

According to some implementations of the disclosure, the response includes at least any of: an evaluation specified by the object for the media item; or a classification specified by the object for the media item.

According to some implementations of the disclosure, a processing module is further included, which is configured to: select a target media item from a plurality of media items by the second machine learning model based on the second object information; and provide the target media item to the object.

FIG. 7 shows a block diagram of a device 700 capable of implementing various implementations of the disclosure. It should be understood that a computing device 700 shown in FIG. 7 is merely illustrative and should not constitute any limitation on the functionality and scope of the implementations described herein. The computing device 700 shown in FIG. 7 may be configured to implement the method described above.

As shown in FIG. 7, the computing device 700 is in a form of a general-purpose computing device. Components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In a multiprocessor system, the plurality of processing units execute computer-executable instructions in parallel to improve the parallel processing capability of the computing device 700.

The computing device 700 generally includes a plurality of computer storage media. Such media may be any available media accessible by the computing device 700, including, but not limited to, volatile and non-volatile media, removable and non-removable media. The memory 720 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 730 may be a removable or non-removable medium and may include a machine-readable medium, such as a flash drive, a magnetic disk, or any other medium, which may be capable of storing information and/or data (e.g., training data for training) and may be accessed within the computing device 700.

The computing device 700 may further include additional removable/non-removable, volatile / non-volatile storage media. Although not shown in FIG. 7, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 720 may include a computer program product 725 having one or more program modules configured to perform various methods or actions of various implementations of the disclosure.

The communication unit 740 implements communication with other computing devices through a communications medium. Additionally, the functionality of components of the computing device 700 may be implemented in a single computing cluster or multiple computing machines capable of communicating through a communication connection. Thus, the computing device 700 may operate in a networked environment using logical connection(s) with one or more other servers, a network personal computers (PC), or another network node.

The input device 750 may be one or more input devices such as a mouse, a keyboard, a trackball, or the like. The output device 760 may be one or more output devices, such as a display, a speaker, a printer, or the like. The computing device 700 may also communicate with one or more external devices (not shown) through the communication unit 740 as needed, the external device such as a storage device, a display device, etc., communicates with one or more devices that enable a user to interact with the computing device 700, or communicates with any device (e.g., network card, modem, etc.) that enables the computing device 700 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for managing a machine learning model, comprising:
determining a prediction of a submission event between an object and a media item provided in an application using a first machine learning model, the prediction of the submission event representing a probability that the object submits a response for a question associated with the media item;
determining a correction weight associated with the object based on the prediction of the submission event;
providing to the object in the application a reference media item and a reference question associated with the reference media item; and
updating a second machine learning model based on a reference response submitted by the object for the reference question and the correction weight in response to receiving the reference response, the second machine learning model describing an association relationship between the object and the reference media item.

2. The method of claim 1, wherein the first machine learning model is determined based on:
obtaining a first reference sample, the first reference sample comprising first object information of a first reference object, first media information of a first reference media item, and a first reference submission event between the first reference object and the first reference media item, and the first reference media item being provided to the first reference object; and
updating the first machine learning model based on the first reference sample.

3. The method of claim 2, wherein obtaining the first reference sample comprises:
providing to the first reference object the first reference media item and a first reference question associated with the first reference media item; and
determining the first reference submission event in the first reference sample based on a first reference response submitted by the first reference object for the first reference question.

4. The method of claim 2, wherein updating the first machine learning model based on the first reference sample comprises:
determining a first prediction of the first reference submission event by the first machine learning model based on the first object information and the first media information; and
updating the first machine learning model based on a first difference between the first reference submission event and the first prediction.

5. The method of claim 1, wherein the correction weight decreases as the prediction of the submission event increases.

6. The method of claim 1, wherein updating the second machine learning model based on the reference response and the correction weight comprises:
determining a second reference sample based on the reference response, the second reference sample comprising second object information of the object, second media information of the reference media item, and the reference response; and
updating the second machine learning model based on the second reference sample and the correction weight.

7. The method of claim 6, wherein updating the second machine learning model based on the second reference sample and the correction weight comprises:
determining a second prediction of the reference response by the second machine learning model based on the second object information and the second media information; and
updating the second machine learning model based on the correction weight and a second difference between the reference response and the second prediction.

8. The method of claim 7, wherein updating the second machine learning model based on the second difference and the correction weight comprises:
determining a loss for updating the second machine learning model based on a product of the second difference and the correction weight; and
updating the second machine learning model based on the loss.

9. The method of claim 1, wherein the first object information is different from the second object information, and the first media information is different from the second media information.

10. The method of claim 1, wherein the response comprises at least any of:
an evaluation specified by the object for the media item; or
a classification specified by the object for the media item.

11. The method of claim 1, further comprising:
selecting a target media item from a plurality of media items by the second machine learning model based on the second object information; and
providing the target media item to the object.

12. An electronic device, comprising:
at least one processor; and
at least one memory coupled to the at least one processor and storing instructions for execution by the at least one processor, the instructions, when executed by the at least one processor, causing the electronic device to perform acts comprising:
determining a prediction of a submission event between an object and a media item provided in an application using a first machine learning model, the prediction of the submission event representing a probability that the object submits a response for a question associated with the media item;
determining a correction weight associated with the object based on the prediction of the submission event;
providing to the object in the application a reference media item and a reference question associated with the reference media item; and
updating a second machine learning model based on a reference response submitted by the object for the reference question and the correction weight in response to receiving the reference response, the second machine learning model describing an association relationship between the object and the reference media item.

13. The electronic device of claim 12, wherein the first machine learning model is determined based on:
obtaining a first reference sample, the first reference sample comprising first object information of a first reference object, first media information of a first reference media item, and a first reference submission event between the first reference object and the first reference media item, and the first reference media item being provided to the first reference object; and
updating the first machine learning model based on the first reference sample.

14. The electronic device of claim 13, wherein obtaining the first reference sample comprises:
providing to the first reference object the first reference media item and a first reference question associated with the first reference media item; and
determining the first reference submission event in the first reference sample based on a first reference response submitted by the first reference object for the first reference question.

15. The electronic device of claim 13, wherein updating the first machine learning model based on the first reference sample comprises:
determining a first prediction of the first reference submission event by the first machine learning model based on the first object information and the first media information; and
updating the first machine learning model based on a first difference between the first reference submission event and the first prediction.

16. The electronic device of claim 12, wherein the correction weight decreases as the prediction of the submission event increases.

17. The electronic device of claim 12, wherein updating the second machine learning model based on the reference response and the correction weight comprises:
determining a second reference sample based on the reference response, the second reference sample comprising second object information of the object, second media information of the reference media item, and the reference response; and
updating the second machine learning model based on the second reference sample and the correction weight.

18. The electronic device of claim 17, wherein updating the second machine learning model based on the second reference sample and the correction weight comprises:
determining a second prediction of the reference response by the second machine learning model based on the second object information and the second media information; and
updating the second machine learning model based on the correction weight and a second difference between the reference response and the second prediction.

19. The electronic device of claim 18, wherein updating the second machine learning model based on the second difference and the correction weight comprises:
determining a loss for updating the second machine learning model based on a product of the second difference and the correction weight; and
updating the second machine learning model based on the loss.

20. A non-transitory computer-readable storage medium having stored thereon computer instructions that, when executed by a processor, cause the processor to perform acts comprising:
determining a prediction of a submission event between an object and a media item provided in an application using a first machine learning model, the prediction of the submission event representing a probability that the object submits a response for a question associated with the media item;
determining a correction weight associated with the object based on the prediction of the submission event;
providing to the object in the application a reference media item and a reference question associated with the reference media item; and
updating a second machine learning model based on a reference response submitted by the object for the reference question and the correction weight in response to receiving the reference response, the second machine learning model describing an association relationship between the object and the reference media item.
